(19) United States
(12) Patent Application Publication
(10) Pub. No.: US 2026/0193048 A1
(43) Pub. Date: Jul. 9, 2026

(54) CONVEYANCE DEVICE

(71) Applicant: Toyo Tire Corporation, Itami-shi (JP)

(72) Inventor: Yoshito NISHIGUCHI, Itami-shi (JP)

(73) Assignee: Toyo Tire Corporation, Itami-shi (JP)

(21) Appl. No.: 19/442,019

(22) Filed: Jan. 7, 2026

(30) Foreign Application Priority Data
Jan. 9, 2025 (JP) 2025-003559

(51) Int. Cl. B65H 5/22; B29D 30/00; B65H 5/14

(52) U.S. Cl. CPC B65H 5/222; B29D 30/0016; B65H 5/14; B29D 2030/0038; B65H 2404/5391; B65H 2801/93

(57) ABSTRACT

A conveyance device that conveys a sheet-shaped rubber member placed on a second feeding table, which is a supply unit, to a receiving conveyor, which is a receiving unit, the conveyance device includes: a plurality of adsorption pads configured to adsorb the sheet-shaped rubber member; a pad support portion on which the plurality of adsorption pads are provided with a gap; a pad moving mechanism configured to move the pad support portion such that the adsorption pads move in a direction approaching or separating from the sheet-shaped rubber member; a contact portion provided in the gap between the plurality of adsorption pads provided on the pad support portion and configured to come into contact with the sheet-shaped rubber member placed on the second feeding table; and a contact portion moving mechanism configured to move the contact portion in a direction approaching or separating from the sheet-shaped rubber member.

### BACKGROUND OF THE INVENTION

### 1. Field of the Invention

The present invention relates to a conveyance device that conveys a sheet-shaped rubber member.

### 2. Description of Related Art

A pneumatic tire is manufactured by forming sheet-shaped rubber members such as an inner liner, a side wall portion, a bead portion, and a tread portion in advance, bonding these sheet-shaped rubber members in a non-vulcanization state to form a green tire, and vulcanizing and molding the green tire.

In the manufacture of the pneumatic tire, a conveyance device that vacuum-adsorbs the sheet-shaped rubber member placed on a table by an adsorption pad and conveys the sheet-shaped rubber member to another table is used in some cases (for example, see WO2007/007405 below).

### SUMMARY OF THE INVENTION

However, in the conveyance device for the sheet-shaped rubber member as disclosed in WO2007/007405, when the adsorption pad adsorbs the sheet-shaped rubber member, the sheet-shaped rubber member may come into close contact with the adsorption pad due to tackiness of the sheet-shaped rubber member and may make it difficult to peel off. When the adsorption pad is peeled from the sheet-shaped rubber member with a large force, the rubber member is loosened, which may cause a joint failure.

Therefore, an object of the invention is to provide a conveyance device for a sheet-shaped rubber member that can easily peel off the sheet-shaped rubber member from an adsorption pad and can convey the sheet-shaped rubber member while preventing deformation such as slack.

The invention includes embodiments to be described below.

[1] A conveyance device that conveys a sheet-shaped rubber member placed on a supply unit to a receiving unit, the conveyance device including:

a plurality of adsorption pads configured to adsorb the sheet-shaped rubber member;

a pad support portion on which the plurality of adsorption pads are provided with a gap;

a pad moving mechanism configured to move the pad support portion such that the adsorption pads move in a direction approaching or separating from the sheet-shaped rubber member;

a contact portion provided in the gap between the plurality of adsorption pads provided on the pad support portion and configured to come into contact with the sheet-shaped rubber member placed on the receiving unit; and

a contact portion moving mechanism configured to move the contact portion in a direction approaching or separating from the sheet-shaped rubber member.

[2] The conveyance device according to [1], in which

the conveyance device conveys the sheet-shaped rubber member of a rectangular shape placed on the supply unit to the receiving unit, and

the contact portion is provided over an entire direction in which two sides of the sheet-shaped rubber member face each other.

[3] The conveyance device according to [2], in which

adsorption pad rows, each including the adsorption pads arranged in a short side direction of the sheet-shaped rubber member, are provided on the pad support portion at intervals in a long side direction of the sheet-shaped rubber member, and

the contact portion is provided over the entire short side direction of the sheet-shaped rubber member between the adsorption pad rows adjacent to each other in the long side direction of the sheet-shaped rubber member.

[4] The conveyance device according to any one of [1] to [3], further including a stopper configured to restrict an interval between the contact portion and the receiving unit from becoming narrower than a predetermined interval.

[5] The conveyance device according to any one of [1] to [4], in which the contact portion is subjected to a non-tackiness treatment.

[6] The conveyance device according to any one of [1] to [5], in which the contact portion has a cylindrical shape and comes into contact with the sheet-shaped rubber member on an outer peripheral surface.

[7] The conveyance device according to any one of [1] to [6], in which the contact portion has a plate shape, and a peripheral edge of a surface to come into contact with the sheet-shaped rubber member is chamfered.

[8] The conveyance device according to any one of [1] to [7], in which the sheet-shaped rubber member adsorbed by the adsorption pads is placed on the receiving unit, and the contact portion is brought into contact with the sheet-shaped rubber member placed on the receiving unit, and then the adsorption pads are separated from the sheet-shaped rubber member.

[9] The conveyance device according to any one of [1] to [8], in which the contact portion moving mechanism moves the contact portion relative to the pad support portion in a direction approaching or separating from the sheet-shaped rubber member.

The conveyance device according to [1], in which a plurality of the contact portions are provided parallel to each other.

The conveyance device according to , further including a frame connecting the plurality of contact portions, in which

the contact portion moving mechanism moves the contact portions via the frame.

The conveyance device according to [2], in which

the contact portion is provided so as to terminate midway from both end portions to a center portion in a short side direction of the sheet-shaped rubber member.

According to the present embodiment, the sheet-shaped rubber member is easily peeled off from the adsorption pad, and the sheet-shaped rubber member can be conveyed while preventing deformation such as slack.

### BRIEF DESCRIPTION OF THE DRAWINGS

FIG. 1 is a schematic plan view showing an entire manufacturing apparatus of a tire member to which a conveyance device according to the present embodiment is applied;

FIG. 2 is a front view of the conveyance device according to the present embodiment;

FIG. 3 is a plan view of a holding mechanism and a contact portion in the conveyance device according to the present embodiment;

FIG. 4 is a front view of the holding mechanism and the contact portion in the conveyance device according to the present embodiment;

FIG. 5 is a cross-sectional view of the conveyance device in which a sheet-shaped rubber member is adsorbed above a receiving conveyor;

FIG. 6 is a cross-sectional view of the conveyance device in which the sheet-shaped rubber member is placed on the receiving conveyor;

FIG. 7 is a cross-sectional view of the conveyance device showing a state in which the contact portion is in contact with the sheet-shaped rubber member;

FIG. 8 is a cross-sectional view of the conveyance device in which an adsorption pad is raised from the state in which the contact portion is in contact with the sheet-shaped rubber member;

FIG. 9 is a cross-sectional view of the conveyance device in which the contact portion is raised after the sheet-shaped rubber member is placed on the receiving conveyor; and

FIG. 10 is a plan view of a holding mechanism and a contact portion in a conveyance device according to Modification 2 of the invention.

### DESCRIPTION OF EMBODIMENTS

Embodiments will be described with reference to the drawings. In the present embodiment, an example in which a conveyance device for a sheet-shaped rubber member is applied to a manufacturing apparatus A of a tire member C used for manufacturing a pneumatic tire such as a carcass ply member will be described. The embodiments to be described below are merely examples, and modifications appropriately made within a range without departing from the gist of the invention are included in the scope of the invention.

### (1) Manufacturing Apparatus of Tire Member C

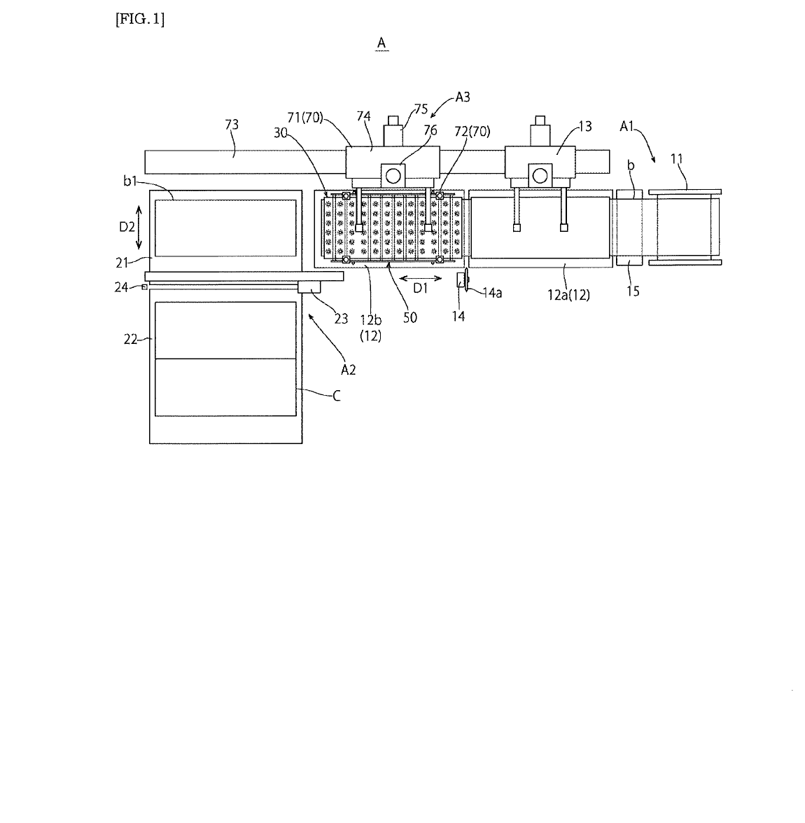

As shown in FIG. 1, the manufacturing apparatus A of the tire member C includes a cutting part A1 that cuts a long strip-shaped material b into a predetermined length to produce a sheet-shaped rubber member b1, a joint part A2 that sequentially joins side edges of the cut sheet-shaped rubber member, and a conveyance device A3 that conveys the sheet-shaped rubber member b1 produced by the cutting part A1 from the cutting part A1 to the joint part A2.

### (2) Cutting Part A1

The cutting part A1 includes a supply unit 11, a feeding table 12, a transfer device 13, and a cutter device 14.

In the supply unit 11, the strip-shaped material b wound in a roll shape is supported by a carriage, and the strip-shaped material b is held in a drawable manner. The strip-shaped material b drawn from the supply unit 11 is placed on the feeding table 12. The transfer device 13 intermittently transfers a leading end side portion of the strip-shaped material b drawn out in a feeding direction along the feeding table 12 onto the feeding table 12 by a predetermined length set in advance at a time. The cutter device 14 cuts the leading end side portion of the strip-shaped material b into a predetermined length every time the strip-shaped material b is intermittently transferred by the transfer device 13.

The feeding table 12 is provided substantially horizontally on a frame. A guide 15 bent downward to receive the strip-shaped material b supplied from the supply unit 11 is provided at an end portion of a supply side of the feeding table 12. The feeding table 12 is divided into a first feeding table 12a on the supply side and a second feeding table 12b extending forward in the feeding direction thereof.

A cutter blade 14a of the cutter device 14 is provided at a separation portion between the first feeding table 12a and the second feeding table 12b. The cutter blade 14a enters the separation portion of the first feeding table 12a and the second feeding table 12b in a state of protruding above the first feeding table 12a and the second feeding table 12b and moves in a width direction orthogonal to the feeding direction of the feeding table 12, thereby cutting the strip-shaped material b on the feeding table 12. Accordingly, the rectangular sheet-shaped rubber member b1 is formed on the second feeding table 12b, with the feeding direction of the feeding table 12 being a long side direction D1 and the width direction of the feeding table 12 being a short side direction D2. At the time of cutting performed by the cutter device 14, the transfer device 13 is controlled to hold a state in which the strip-shaped material b is pressed on the first feeding table 12a.

### (3) Joint Part A2

The joint part A2 includes a receiving conveyor 21, a feeding conveyor 22, and a joining device 23 provided between the receiving conveyor 21 and the feeding conveyor 22.

The receiving conveyor 21 functions as a receiving unit that receives the sheet-shaped rubber members b1 cut by the cutting part A1 and sequentially placed thereon by the conveyance device A3. The receiving conveyor 21 intermittently conveys the sheet-shaped rubber member b1 received from the conveyance device A3 in a direction orthogonal to the feeding direction of the feeding table 12 with both side edges, which are uncut ends, facing forward and backward.

The receiving conveyor 21 detects the side edge on a front side of the conveyed sheet-shaped rubber member b1 by a sensor 24 disposed on an upper front side thereof. When the sensor 24 detects the side edge on the front side of the moving sheet-shaped rubber member b1, the receiving conveyor 21 stops the conveyance of the sheet-shaped rubber member b1. Accordingly, the receiving conveyor 21 can position the side edge on the front side of the sheet-shaped rubber member b1 at a predetermined joint position.

The feeding conveyor 22 is arranged in series in front of the receiving conveyor 21 and is configured to convey the single sheet-shaped rubber member b1 or the continuous sheet-shaped rubber member b1 formed of a plurality of joined sheets forward or retract it backward in an opposite direction.

The feeding conveyor 22 feeds the sheet-shaped rubber member b1 transferred from the receiving conveyor 21 to a predetermined position, and then retracts the sheet-shaped rubber member b1. When the sensor 24 detects the side edge on a rear side of the retracting sheet-shaped rubber member b1, the feeding conveyor 22 stops the conveyance of the sheet-shaped rubber member b1. Accordingly, the feeding conveyor 22 can position the rear side of the sheet-shaped rubber member b1 at a predetermined joint position.

By the movements of the receiving conveyor 21 and the feeding conveyor 22 as described above, the side edge on the rear side of the sheet-shaped rubber member b1 on the feeding conveyor 22 and the side edge on the front side of the sheet-shaped rubber member b1 on the receiving conveyor 21 can be positioned in an abutting state at the predetermined joint position.

The joining device 23 positions the side edge on the rear side of the sheet-shaped rubber member b1 placed on the feeding conveyor 22 and the side edge on the front side of the sheet-shaped rubber member b1 to be conveyed next by the feeding conveyor 22 at the predetermined positions, respectively, and joins them in the abutting state, thereby producing the tire member C.

### (4) Conveyance Device A3

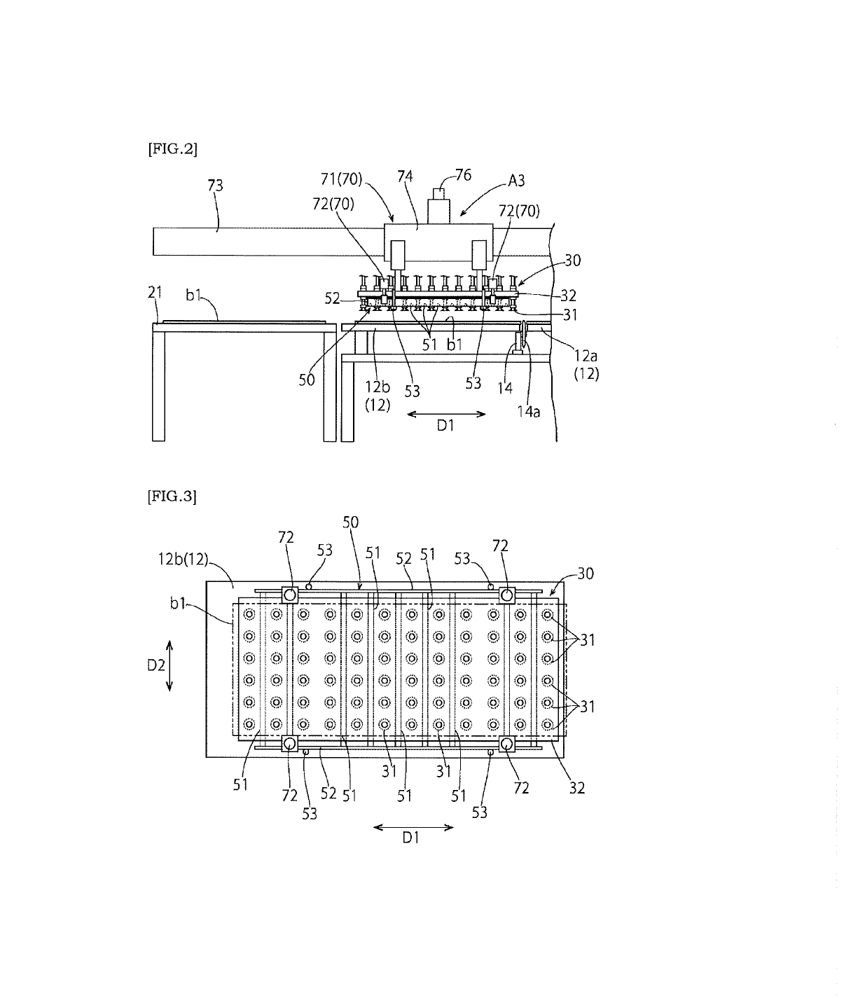

As shown in FIGS. 1 and 2, the conveyance device A3 includes a holding mechanism 30 that holds the sheet-shaped rubber member b1, a peeling mechanism 50 that peels the sheet-shaped rubber member b1 held by the holding mechanism 30 from the holding mechanism 30, and a moving mechanism 70 that moves the holding mechanism 30 and the peeling mechanism 50.

The holding mechanism 30 includes a plurality of adsorption pads 31 that adsorb the sheet-shaped rubber member b1, and a flat plate-shaped pad support portion 32 disposed so as to face an upper side of the sheet-shaped rubber member b1 formed on the second feeding table 12b.

The plurality of adsorption pads 31 are provided so as to protrude downward from a lower surface of the pad support portion 32. In the present embodiment, as shown in FIGS. 3 and 4, adsorption pad rows each including the adsorption pads 31 arranged at intervals in the short side direction D2 of the sheet-shaped rubber member b1 are provided at intervals in the long side direction D1 of the sheet-shaped rubber member b1.

The adsorption pad 31 includes a depressurized space connected to an adsorption device such as a vacuum device. The adsorption pad 31 adsorbs the sheet-shaped rubber member b1 at an opening provided in the depressurized space and opening downward.

The peeling mechanism 50 includes a plurality of contact portions 51 provided in gaps between the adsorption pads 31 below the pad support portion 32 of the holding mechanism 30, a frame 52 connecting the plurality of contact portions 51, and stoppers 53.

Each contact portion 51 includes, for example, a cylindrical rod extending in the short side direction D2 of the sheet-shaped rubber member b1. The contact portions 51 are provided parallel to each other, one between each pair of the adsorption pad rows adjacent to each other in the long side direction D1 of the sheet-shaped rubber member b1. The contact portion 51 is longer than a length of the sheet-shaped rubber member b1 in the short side direction D2. The contact portion 51 is provided over the entire short side direction D2 of the sheet-shaped rubber member b1. The contact portion 51 comes into contact with an upper surface of the sheet-shaped rubber member b1 held by the adsorption pad 31 to peel the sheet-shaped rubber member b1 from the adsorption pad 31.

As shown in FIG. 4, end portions of the plurality of contact portions 51 in the short side direction D2 are connected to the frame 52. The frame 52 is attached to the pad support portion 32 of the holding mechanism 30 via a contact portion moving mechanism 72 described later.

As shown in FIG. 4, the frame 52 is provided with the stoppers 53 protruding downward than the contact portions 51. In a state in which the stoppers 53 are in contact with an upper surface of the receiving conveyor 21, an interval having a size corresponding to a thickness of the sheet-shaped rubber member b1 is formed between the contact portion 51 and the upper surface of the receiving conveyor 21. The interval having the size corresponding to the thickness of the sheet-shaped rubber member b1 may be a length equal to the thickness of the sheet-shaped rubber member b1, or may be smaller or larger than the thickness of the sheet-shaped rubber member b1.

A lower surface of the contact portion 51 that comes into contact with the sheet-shaped rubber member b1 is preferably subjected to a non-tackiness treatment for preventing adhesion of the sheet-shaped rubber member b1 to the contact portion 51. Examples of the non-tackiness treatment include a treatment of imparting unevenness to the surface of the contact portion 51, such as blasting treatment, and a treatment of providing unevenness on the surface of the contact portion 51 and filling a recess provided in the surface with a synthetic resin such as a fluoro resin.

The moving mechanism 70 includes a pad moving mechanism 71 that moves the pad support portion 32 of the holding mechanism 30, and the contact portion moving mechanism 72 that moves the peeling mechanism 50 in a vertical direction.

The pad moving mechanism 71 includes a rail 73 provided in parallel with the feeding table 12 from the second feeding table 12b to the receiving conveyor 21 of the joint part A2, and a moving table 74 that slides on the rail 73.

A moving motor 75 is mounted on the moving table 74. When the motor 75 operates, the moving table 74 moves between the second feeding table 12b and the receiving conveyor 21. The holding mechanism 30 is attached to the moving table 74 via a cylinder device 76. The holding mechanism 30 and the peeling mechanism 50 move up and down above the second feeding table 12b and the receiving conveyor 21 by the operation of the cylinder device 76.

The contact portion moving mechanism 72 is provided on the pad support portion 32 of the holding mechanism 30. The contact portion moving mechanism 72 causes the frame 52 of the peeling mechanism 50 to move up and down with respect to the holding mechanism 30. Accordingly, the contact portion moving mechanism 72 causes the plurality of contact portions 51 connected to the frame 52 to move up and down independently of the pad support portion 32.

The moving mechanism 70 having such a configuration controls the motor 75 and the cylinder device 76 of the pad moving mechanism 71 and the contact portion moving mechanism 72 to adsorb and hold the sheet-shaped rubber member b1 placed on the second feeding table 12b and convey the sheet-shaped rubber member b1 to the receiving conveyor 21.

### (5) Operation of Conveyance Device A3

Next, an operation in which the conveyance device A3 conveys the sheet-shaped rubber member b1 placed on the second feeding table 12b to the receiving conveyor 21 will be described.

First, the long strip-shaped material b is drawn out from the supply unit 11 onto the feeding table 12 in advance, and the leading end side portion thereof is drawn out to a predetermined position on the first feeding table 12a and the second feeding table 12b. In this state, the transfer device 13 presses and holds the strip-shaped material b on the first feeding table 12a, and the holding mechanism 30 presses and holds the strip-shaped material b on the second feeding table 12b. At this time, the adsorption pad 31 of the holding mechanism 30 may adsorb the strip-shaped material b. Then, the cutter device 14 is operated, and the strip-shaped material b is cut in the width direction by the cutter blade 14a to form the sheet-shaped rubber member b1 on the second feeding table 12b.

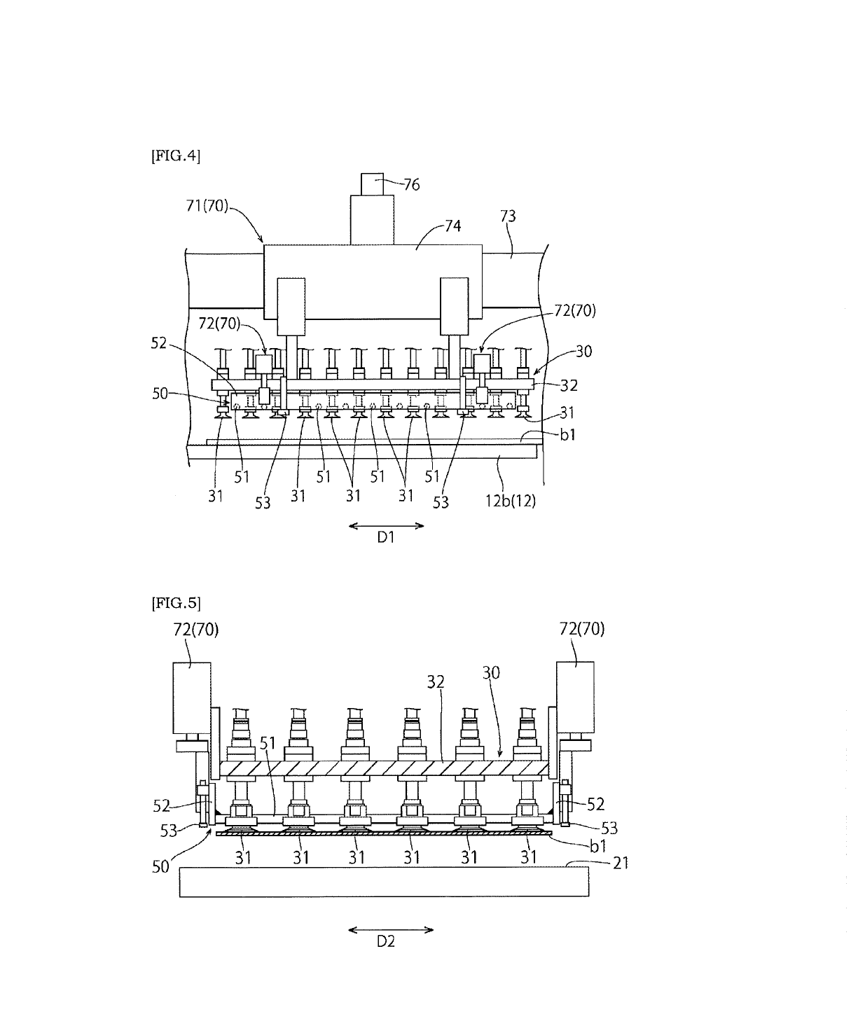

When the sheet-shaped rubber member b1 is formed on the second feeding table 12b, after the sheet-shaped rubber member b1 is absorbed by the adsorption pads 31 of the holding mechanism 30, the moving mechanism 70 controls the motor 75 and the cylinder device 76 of the pad moving mechanism 71 to move the holding mechanism 30 and the peeling mechanism 50 attached to the holding mechanism 30 via the contact portion moving mechanism 72 to an upper side of the receiving conveyor 21 as shown in FIG. 5. In this state, the contact portions 51 are disposed at positions away from the upper side of the sheet-shaped rubber member b1.

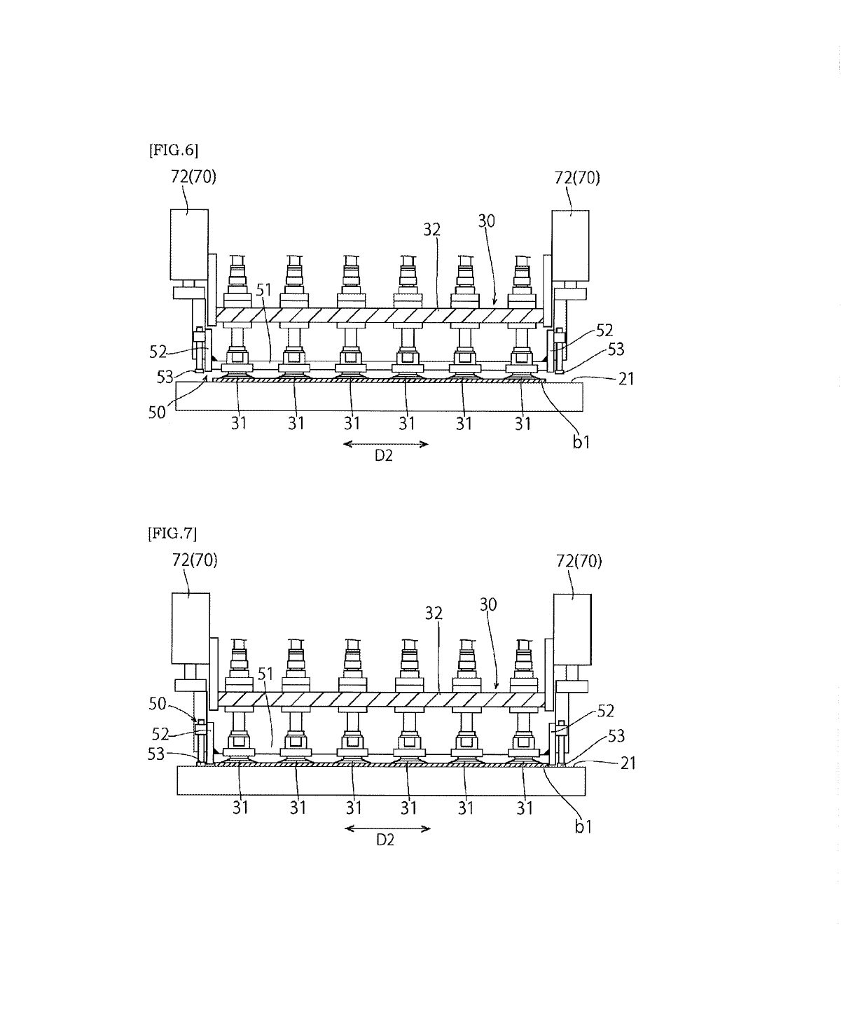

Next, the moving mechanism 70 controls the cylinder device 76 of the pad moving mechanism 71 to move the holding mechanism 30 and the peeling mechanism 50 downward and place the sheet-shaped rubber member b1 held by the adsorption pads 31 on the receiving conveyor 21 (see FIG. 6).

Next, after the adsorption of the sheet-shaped rubber member b1 by the adsorption pads 31 of the holding mechanism 30 is released, the moving mechanism 70 controls the contact portion moving mechanism 72 to move the peeling mechanism 50 downward with respect to the holding mechanism 30 and bring the contact portions 51 into contact with the sheet-shaped rubber member b1 from the upper side. At this time, the stoppers 53 provided in the peeling mechanism 50 come into contact with the receiving conveyor 21, and the interval having the size corresponding to the thickness of the sheet-shaped rubber member b1 is formed between the contact portions 51 and the upper surface of the receiving conveyor 21 (see FIG. 7).

Next, the moving mechanism 70 controls the cylinder device 76 of the pad moving mechanism 71 and the contact portion moving mechanism 72 to move the holding mechanism 30 upward while keeping the contact portions 51 in contact with the sheet-shaped rubber member b1 (see FIG. 8). Accordingly, since the adsorption pads 31 move upward in a state in which the sheet-shaped rubber member b1 is pressed down from above by the plurality of contact portions 51, even if the sheet-shaped rubber member b1 is in close contact with the adsorption pads 31, the sheet-shaped rubber member b1 is peeled off from the adsorption pads 31 by the contact portions 51 and does not move upward together with the adsorption pads 31.

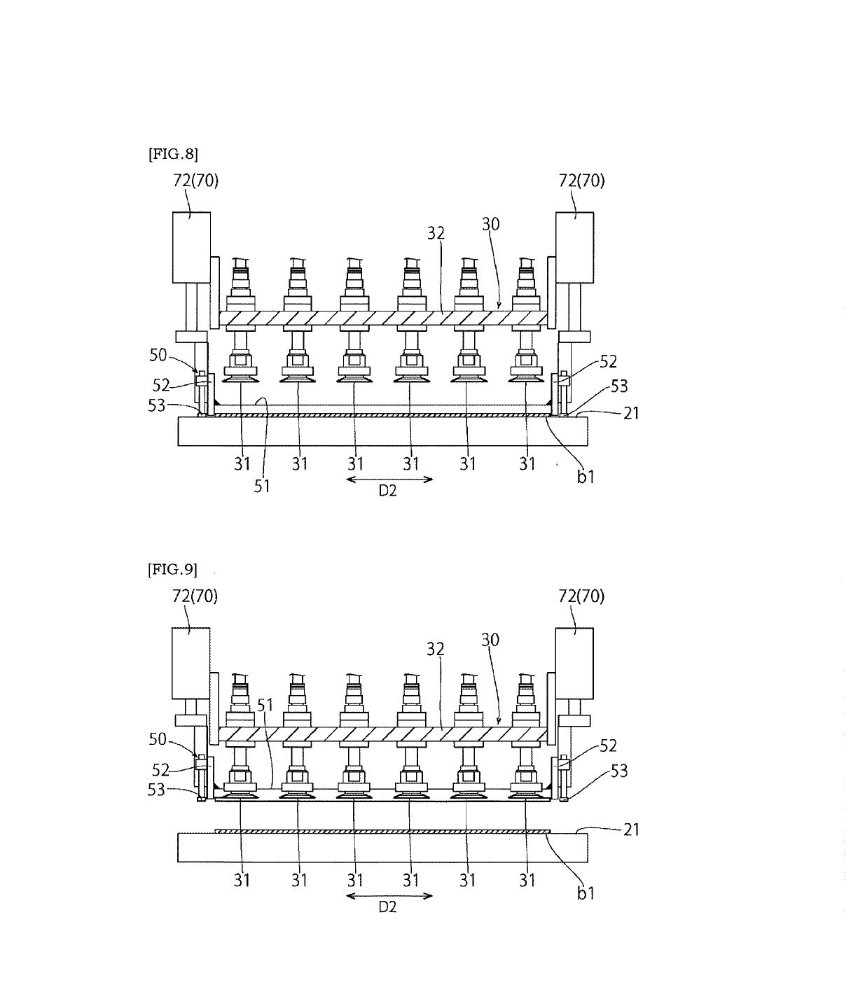

Then, as shown in FIG. 9, the moving mechanism 70 controls the contact portion moving mechanism 72 to move the peeling mechanism 50 upward to peel the contact portions 51 from the sheet-shaped rubber member b1, and controls the pad moving mechanism 71 to move the holding mechanism 30 to the second feeding table 12b.

### (6) Effects

In the conveyance device A3 according to the present embodiment as described above, the contact portions 51 that come into contact with the sheet-shaped rubber member b1 placed on the receiving conveyor 21 are provided in the gap between the plurality of adsorption pads 31, and the contact portion 51 is provided to be movable up and down by the contact portion moving mechanism 72. Therefore, in the conveyance device A3, the adsorption pad 31 can be moved upward while the sheet-shaped rubber member b1 is pressed by the contact portions 51, and even when the sheet-shaped rubber member b1 is in close contact with the adsorption pads 31, the sheet-shaped rubber member b1 can be peeled off from the adsorption pads 31 while preventing deformation of the sheet-shaped rubber member b1.

In the present embodiment, the contact portions 51 are provided over the entire short side direction D2 of the sheet-shaped rubber member b1 between the adsorption pad rows adjacent to each other in the long side direction D1 of the sheet-shaped rubber member b1. Therefore, when the sheet-shaped rubber member b1 is peeled off from the adsorption pads 31, a center portion of the sheet-shaped rubber member b1 that is prone to deformation such as slack can be pressed from above by the contact portions 51, and the deformation of the center portion can be prevented.

In the present embodiment, the peeling mechanism 50 is provided with the stoppers 53, and in a state in which the stoppers 53 are in contact with the upper surface of the receiving conveyor 21, the interval having the size corresponding to the thickness of the sheet-shaped rubber member b1 is formed between the contact portion 51 and the upper surface of the receiving conveyor 21. Therefore, the contact portions 51 can be disposed at appropriate positions without controlling the positions of the contact portions 51 in the vertical direction with high accuracy by the pad moving mechanism 71 or the contact portion moving mechanism 72.

In the present embodiment, since the surface of the contact portion 51 is subjected to the non-tackiness treatment, when the peeling mechanism 50 is moved upward, the contact portion 51 can be smoothly peeled off from the sheet-shaped rubber member b1.

Further, in the present embodiment, since the contact portion 51 has a cylindrical shape, a contact area of the contact portion 51 with respect to the sheet-shaped rubber member b1 can be reduced, and when the peeling mechanism 50 is moved upward, the contact portion 51 can be smoothly peeled off from the sheet-shaped rubber member b1.

### (7) Modifications

Next, modifications will be described. Various modifications can be made to the above embodiments without departing from the spirit of the invention. Although a plurality of modification examples will be described below, any one of the plurality of modification examples described below may be applied to the above-described embodiment, or any two or more of the modification examples described below may be applied in combination. In addition to the following modifications, various modifications are possible.

### (8) Modification 1

In the above embodiment, the contact portion 51 is formed of a cylindrical rod. Alternatively, it may be a prismatic rod or a plate-shaped body. When the contact portion 51 is formed of a plate-shaped body, a peripheral edge of a surface (that is, the lower surface) to come into contact with the sheet-shaped rubber member b1 is preferably chamfered. By chamfering the peripheral edge of the contact portion 51 formed of the plate-shaped body, the sheet-shaped rubber member b1 is less likely to be damaged when the contact portions 51 come into contact with the sheet-shaped rubber member b1, and the contact portions 51 are easily peeled off from the sheet-shaped rubber member b1.

### (9) Modification 2

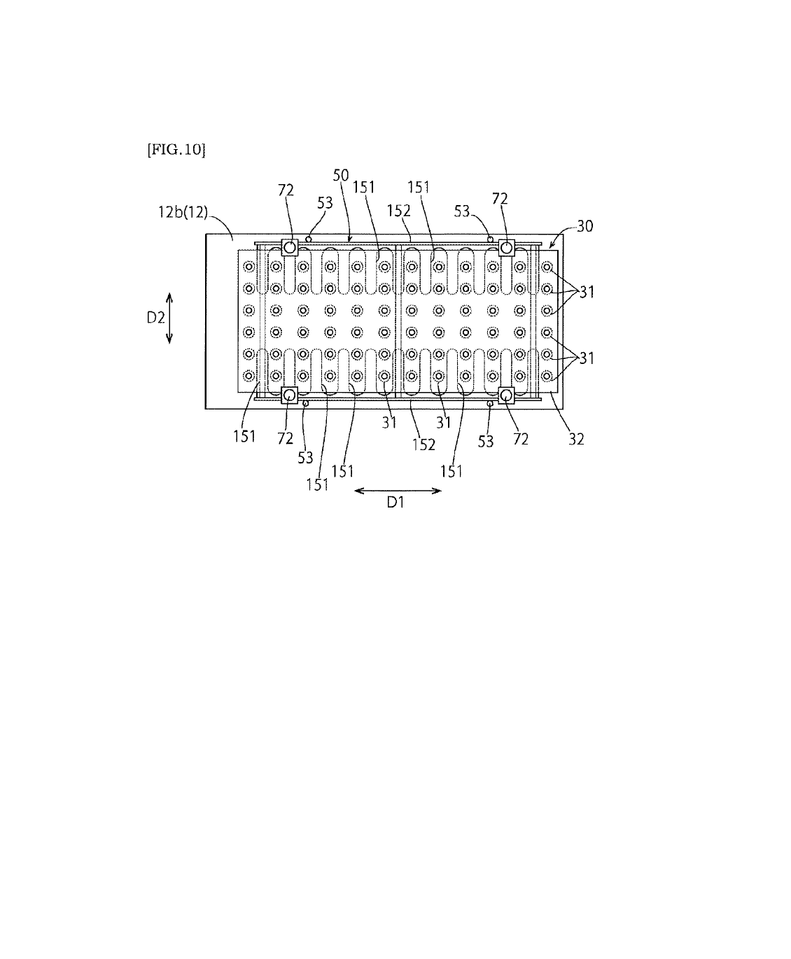

In the above embodiment, the case in which the plurality of contact portions 51 are provided over the entire short side direction D2 of the sheet-shaped rubber member b1 is described. Alternatively, as shown in FIG. 10, a plurality of contact portions 151 may be provided so as to terminate on a way from frames 152 disposed at both end portions in the short side direction D2 of the sheet-shaped rubber member b1 to a center portion in the short side direction D2. The same components as those of the above-described embodiment are denoted by the same reference numerals, and the description thereof will be omitted.

### (10) Modificaton 3

In the above embodiment, the contact portions 51 are provided so as to extend in the short side direction D2 of the sheet-shaped rubber member b1. Alternatively, the contact portions may be provided so as to extend in the long side direction D1 of the sheet-shaped rubber member b1, or the contact portions may be provided in a lattice shape in which the contact portions extending in the short side direction D2 and the contact portions extending in the long side direction D1 intersect one another.

### Reference Signs List

A: manufacturing apparatus

A1: cutting part

A2: joint part

A3: conveyance device

B: strip-shaped material

B1: sheet-shaped rubber member

D1: long side direction

D2: short side direction

11: supply unit

12: feeding table

12a: first feeding table

12b: second feeding table

13: transfer device

15: guide

21: receiving conveyor

22: feeding conveyor

23: joining device

30: holding mechanism

31: adsorption pad

32: pad support portion

50: peeling mechanism

51: contact portion

52: frame

53: stopper

70: moving mechanism

71: pad moving mechanism

72: contact portion moving mechanism

What is claimed is:

1. A conveyance device that conveys a sheet-shaped rubber member placed on a supply unit to a receiving unit, the conveyance device comprising:
a plurality of adsorption pads configured to adsorb the sheet-shaped rubber member;
a pad support portion on which the plurality of adsorption pads are provided with a gap;
a pad moving mechanism configured to move the pad support portion such that the adsorption pads move in a direction approaching or separating from the sheet-shaped rubber member;
a contact portion provided in the gap between the plurality of adsorption pads provided on the pad support portion and configured to come into contact with the sheet-shaped rubber member placed on the receiving unit; and
a contact portion moving mechanism configured to move the contact portion in a direction approaching or separating from the sheet-shaped rubber member.

2. The conveyance device according to claim 1, wherein
the conveyance device conveys the sheet-shaped rubber member of a rectangular shape placed on the supply unit to the receiving unit, and
the contact portion is provided over an entire direction in which two sides of the sheet-shaped rubber member face each other.

3. The conveyance device according to claim 2, wherein
adsorption pad rows, each including the adsorption pads arranged in a short side direction of the sheet-shaped rubber member, are provided on the pad support portion at intervals in a long side direction of the sheet-shaped rubber member, and
the contact portion is provided over the entire short side direction of the sheet-shaped rubber member between the adsorption pad rows adjacent to each other in the long side direction of the sheet-shaped rubber member.

4. The conveyance device according to claim 1, further comprising:
a stopper configured to restrict an interval between the contact portion and the receiving unit from becoming narrower than a predetermined interval.

5. The conveyance device according to claim 1, wherein
the contact portion is subjected to a non-tackiness treatment.

6. The conveyance device according to claim 1, wherein
the contact portion has a cylindrical shape and comes into contact with the sheet-shaped rubber member on an outer peripheral surface.

7. The conveyance device according to claim 1, wherein
the contact portion has a plate shape, and a peripheral edge of a surface to come into contact with the sheet-shaped rubber member is chamfered.

8. The conveyance device according to claim 1, wherein
the sheet-shaped rubber member adsorbed by the adsorption pads is placed on the receiving unit, and the contact portion is brought into contact with the sheet-shaped rubber member placed on the receiving unit, and then the adsorption pads are separated from the sheet-shaped rubber member.

9. The conveyance device according to claim 1, wherein
the contact portion moving mechanism moves the contact portion with respect to the pad support portion in a direction approaching or separating from the sheet-shaped rubber member.

10. The conveyance device according to claim 1, wherein
a plurality of the contact portions are provided parallel to each other.

11. The conveyance device according to claim 10, further comprising:
a frame connecting the plurality of contact portions, wherein
the contact portion moving mechanism moves the contact portions via the frame.

12. The conveyance device according to claim 2, wherein
the contact portion is provided so as to terminate midway from both end portions to a center portion in a short side direction of the sheet-shaped rubber member.
